(19) United States
(12) Patent Application Publication
(10) Pub. No.: US 2026/0237246 A1
(43) Pub. Date: Aug. 13, 2026

(54) ARTIFICIAL INTELLIGENCE SYSTEM AND METHOD FOR DETECTING AUTOMOTIVE COMPONENT FAILURES

(71) Applicant: Innova Electronics Corporation, Irvine, CA (US)

(72) Inventors: Phuong Pham, Fountain Valley, CA (US); Ly Bach, Ho Chi Minh City (VN); Tai Mai, Ho Chi Minh City (VN); Hoang Nguyen, Dinh Quan District (VN)

(21) Appl. No.: 19/048,633

(22) Filed: Feb. 7, 2025

(51) Int. Cl. G07C 5/00; G07C 5/08

(52) U.S. Cl. CPC G07C 5/008; G07C 5/0816

(57) ABSTRACT

A system and method establishes normal operating values of automotive electronic components and detects deviations in real-time. Diagnostic data from a vehicle's sensors and control units are streamed to a cloud-based platform, where historical data is aggregated and averaged to determine normal values under defined operating conditions. Incoming sensor readings are compared against these established baselines, and anomalies exceeding a predefined percentage threshold, detected over multiple occurrences, trigger the transmission of a user alert via a mobile application. The approach leverages secure data transmission, machine learning algorithms for adaptive baseline refinement, and user-friendly notification interfaces, enabling proactive maintenance and early detection of component faults before they escalate into more significant failures.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to using artificial intelligence and machine learning to detect automotive component failures. The disclosure more particularly relates to establishing normal values for vehicle components by ongoing measurement of live data from an on-board vehicle diagnostics system and determining failures in accordance with detected deviations from the established normal values.

### 2. Description of the Related Art

On-board diagnostics (OBD) systems trace their roots back to the early 1980s, although some precursors appeared as early as the late 1960s and 1970s when electronics first began influencing automotive design. As engine controls and emissions regulations became more stringent, automotive manufacturers began implementing rudimentary self-diagnostic capabilities. Initially, these early systems were brand-specific and proprietary. They typically employed basic electronics to monitor key engine parameters such as ignition timing, fuel delivery, and exhaust emissions, generating simple error indicators (often a check engine light) if readings drifted out of a permissible range. However, these first attempts at OBD were limited in scope: they lacked standardization, provided only minimal information, and required specialized manufacturer tools to interpret rudimentary trouble codes.

The turning point came in the late 1980s and early 1990s when heightened environmental awareness and regulatory pressure spurred a push for cleaner automotive emissions. In the United States, the California Air Resources Board (CARB) took a pioneering role by mandating early OBD standards in order to ensure that vehicles would maintain low emission levels throughout their operational life. This led to the first generation commonly referred to as OBD-I. Although OBD-I systems varied widely among manufacturers, their central idea was to continuously monitor emissions-related components and alert the driver when something went wrong. Each automaker had its own communication protocols and code structures, making diagnostics inconsistent across different brands and models. Tools needed to read these codes were often expensive and brand-specific, and the codes themselves offered only basic fault identification.

The real watershed came with OBD-II, which was standardized in the United States for all cars sold from the 1996 model year onward. OBD-II established a uniform set of diagnostic trouble codes (DTCs) and a standardized communication protocol. It defined a set of parameters to monitor, ranging from engine misfires and oxygen sensor readings to fuel trim, evaporative emissions, and catalytic converter efficiency. With OBD-II, technicians and even do-it-yourself enthusiasts could purchase a single diagnostic scanner or code reader that would work on any compliant vehicle. This universality, combined with more sophisticated sensor arrays and improved computing power, revolutionized how technicians diagnosed and repaired automotive faults. It provided more extensive and nuanced data, making the diagnostic process more accurate and less reliant on guesswork or trial-and-error methods.

Throughout the 2000s and into the 2010s, the OBD-II standard continued to evolve. The inclusion of Controller Area Network (CAN) bus as a required communication protocol starting around 2008 in the U.S. made data transfers more efficient and reliable. The increasing complexity of modern engines, the rise of hybrid and electric powertrains, and advanced emissions control technology demanded even more from OBD systems. Many jurisdictions outside the United States adopted variants of OBD, often referred to as EOBD (European OBD) or JOBD (Japanese OBD), each incorporating their own regional regulations while maintaining broad compatibility and standardization.

By this time, OBD systems were no longer strictly about emissions and engine fault detection. The systems had grown capable of diagnosing a wide range of vehicle conditions, from transmission slips to advanced sensor malfunctions. The data stream accessible through OBD-II ports gave technicians and third-party developers the ability to create sophisticated diagnostic tools and even smartphone-based apps. This democratization of information meant that vehicle owners could use affordable adapters to read trouble codes, monitor real-time performance data, and better understand their car's health.

### BRIEF SUMMARY

In accordance with an example embodiment of the present disclosure, methods and corresponding systems facilitate the early detection of abnormal conditions in automotive components by establishing dynamic baseline parameters and continuously comparing incoming sensor data against these baselines. Under normal operation, streaming diagnostic data from a vehicle's onboard sensors is captured and transmitted to a cloud-based server. This server analyzes the historical data for each component and aggregates it to define a “normal value” representing typical performance under specific operating conditions. As new data arrives, it is evaluated against this adaptive baseline to identify subtle deviations that may not be recognized by static threshold-based diagnostics.

The system suitably supplies emphasis on both the magnitude of the deviation and its frequency. Rather than relying on a single excursion beyond predefined limits, the method monitors whether the component's reading surpasses a given percentage threshold a certain number of times. For example, deviations in the range of 5% to 15% from the normal value might be considered suspicious, but only if they occur persistently, such as three or more times, rather than as a one-off anomaly. By taking into account the recurrence of abnormal values, the system reduces false alarms and concentrates on issues that are likely to indicate genuine component degradation or malfunction.

Over time, the system's sensitivity and accuracy improve. As the vehicle continues to operate and produce diagnostic data, newly acquired readings are incorporated into the historical dataset, refining the baseline and adapting it to changes in the vehicle's condition, usage patterns, and environmental factors. Machine learning algorithms can further enhance this adaptive process, allowing the system to learn from past events and continuously improve its predictive capabilities. Components that experience subtle wear or evolving performance parameters are thus accounted for, ensuring that normal values remain realistic and relevant even as the vehicle ages or conditions shift.

Upon detecting a confirmed anomaly, one that meets both the magnitude and frequency requirements, the system transmits a user notification via a connected application. This notification may include details about which component is exhibiting abnormal behavior and recommend maintenance actions or further diagnostics. The alert prioritizes the user's awareness and safety, prompting timely service that might prevent more serious damage or sudden failures. By integrating severity ratings and correlated anomaly detection, the approach guides the user toward appropriate responses based on the urgency and complexity of the detected issue.

An apparatus configured according to these principles includes a diagnostic interface to gather streaming data, a communication module to send it securely to the cloud server, and a processor that cooperates with the server to compute, compare, and identify abnormal conditions. A software medium, in turn, provides instructions that, when executed, carry out these operations, receiving, comparing, classifying, and alerting, while also supporting adaptive threshold refinement and optional data protection measures. The entire framework is compatible with standard automotive diagnostic ports and common OBD-II protocols, encouraging broad applicability and simple integration into diverse vehicle platforms.

This comprehensive approach effectively bridges the gap between raw sensor measurements and meaningful, actionable insights. By dynamically setting baselines, analyzing both the level and persistence of anomalies, refining normal values through continuous learning, and delivering timely user notifications, it offers a proactive means of maintaining vehicle health and reliability.

### BRIEF DESCRIPTION OF THE DRAWINGS

These and other features and advantages of the various embodiments disclosed herein will be better understood with respect to the following description and drawings, in which:

FIG. 1 is an example embodiment of a system for artificial intelligence based detection of automotive component failures.

FIG. 2 is an example embodiment of a digital data processing system;

FIG. 3 is a flowchart of an example embodiment of an artificial intelligence system for detecting automotive component failures;

FIG. 4 is an example embodiment of an artificial intelligence/machine learning platform that is suitably integrated into an automotive diagnostic solution as a cloud-based machine learning pipeline;

FIGS. 5A and 5B are flowcharts of an example embodiment of a use case for an artificial intelligence system for detecting automotive component failures;

FIG. 6 is a line graph displaying two overlapping curves to compare what is considered normal operating behavior against a scenario containing an abnormal event.

### DETAILED DESCRIPTION

The detailed description set forth below in connection with the appended drawings is intended as a description of certain embodiments of a vehicle diagnostic system and related method, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Historically, automotive diagnostic approaches primarily relied on OBD systems embedded directly in the vehicle's electronic control units. These early systems were based on predefined thresholds and rules set by manufacturers. For instance, if a sensor reading rose above or fell below a certain fixed limit, the check engine light would illuminate or a generic trouble code would be stored. While this allowed mechanics to identify issues, it was often limited to broad categories of faults rather than continuous, nuanced analysis.

Over time, portable scan tools and aftermarket diagnostic devices emerged, allowing mechanics and experienced enthusiasts to pull error codes and interpret them. These tools made it easier to access the onboard diagnostics, but they were still rooted in the concept of responding to existing fault codes and known thresholds. Data logging devices, which recorded performance parameters over time, referred to as live data, offered more information but still left much of the interpretation to a human expert or to software running on a local device without external reference points.

As telematics and connectivity improved, some systems started sending vehicle diagnostic data to remote servers for analysis and storage. Manufacturers and specialized service providers could then compare data from multiple vehicles to identify patterns. However, these comparisons were still generally not performed in real time and lacked adaptive algorithms that learned from historical data. Artificial intelligence (AI) and machine learning (ML), where baseline conditions are established dynamically and abnormal values are detected by comparing new data against previously stored averages offers a significant departure from these earlier, more static methods of fault detection.

Example embodiments herein use dynamic, data-driven comparisons rather than relying solely on pre-programmed thresholds and static fault codes. Unlike traditional systems that depend on fixed parameters and react only after certain hard limits are breached, this approach involves continuous collection and storage of a vehicle's normal operating data in the cloud. Over time, the AI component learns what constitutes typical performance for each electronic component. Incoming sensor readings are then compared to these evolving benchmarks, rather than a one-size-fits-all factory setting. Whenever values deviate significantly and repeatedly from this learned baseline, the system identifies a potential failure and immediately alerts the user. By combining cloud-based historical data, real-time streaming analysis, and adaptive AI-driven baselines, the system moves beyond conventional threshold-based diagnostics and offers a more nuanced, early-warning approach to detecting and addressing electronic component failures.

Example embodiments provide a system to detect potential failures in automotive electronic components by using a combination of onboard vehicle diagnostics, cloud-based data storage, cellular communication, and artificial intelligence analysis. It functions to identify abnormal sensor readings before they lead to component breakdowns or safety hazards. This approach relies on building a historical baseline of what is considered “normal” behavior for a vehicle's various electronic systems, then comparing new sensor inputs to these established patterns in order to recognize when something deviates significantly.

During regular operation of the vehicle, diagnostic data is continuously gathered from the onboard computer and recorded. These readings, which may include temperature, pressure, voltage, and other performance metrics, are transmitted to a central automotive diagnostic and service center for storage on the cloud. Over time, this creates a reliable database of average values under typical conditions. The AI system uses these accumulated historical values as a reference to establish normal operating ranges and performance thresholds.

When a new set of data arrives, it is analyzed against the historical baseline. Any reading that consistently falls outside the established normal range is flagged as potentially abnormal. If such abnormal readings occur more than a predefined number of times, such as three or more consecutive instances, or deviate significantly from the average values by a certain percentage, such as more than ten percent, the system concludes there may be an electronic component failure. Once such a deviation is confirmed, the system alerts the user through a connected application, providing a timely warning that a particular sensor or component requires attention. This process ensures that problems can be addressed proactively, helping to prevent more extensive damage, improve vehicle reliability, and enhance overall driver safety.

Traditional OBD systems that rely on static thresholds or wait for a hard fault to occur before triggering a warning can lead to dangerous situations. For example, a slight but persistent increase in engine temperature might not immediately set an OBD trouble code. Left unaddressed, this slow rise in heat could eventually cause the engine to overheat unexpectedly, leading to severe mechanical damage or roadside breakdowns. Similarly, a fuel injector beginning to fail might deliver slightly more fuel than normal, increasing emissions and wasting fuel without triggering a code right away. Over time, this excess fuel can damage internal components or create a fire hazard if undetected. Another scenario involves intermittent sensor malfunctions, where a critical input (such as a wheel speed sensor influencing braking systems) provides occasional faulty readings that never fully cross an OBD threshold. This can result in compromised braking performance not flagged by traditional systems until it becomes acute. Continuously comparing new data against a dynamically updated baseline and recognizing patterns of abnormal readings, rather than waiting for a single large deviation, identifies early warning signs. As a result, dangerous temperature spikes, evolving emissions problems, and subtle sensor faults are addressed sooner, reducing the risk of sudden failures, accidents, or extensive damage.

Consider a scenario in which a vehicle's oxygen (O₂) sensor gradually begins drifting out of its normal range, but not enough to trigger a traditional error code. With older diagnostic technologies, the sensor would need to exceed a fixed threshold before the check engine light illuminated. This approach often allowed minor issues to go unnoticed until they became more severe or impacted fuel economy and emissions. In contrast, example embodiments herein continuously records what “normal” looks like for that specific sensor based on historical patterns. When the O₂ sensor readings begin to deviate even slightly from the established norm, the invention flags this subtle but consistent change. Rather than waiting for a threshold breach, the system provides an early warning to the user, giving them the chance to address the problem before it escalates.

Another example involves intermittently failing sensors, such as a coolant temperature sensor, that only occasionally reports abnormal values. Traditional systems might ignore these sporadic anomalies if they do not surpass predetermined fault limits, leaving the driver unaware until a full-blown malfunction occurs. In example embodiments herein, each abnormal reading, even if mild, is recorded and compared against the sensor's historical average. After a few such instances, by way of example, three or more, the system determines that these anomalies are no coincidence. By factoring in both frequency and percentage deviations, the system recognizes a developing issue and alerts the driver, enabling prompt maintenance instead of waiting for a major malfunction or visible symptom.

Additionally, example embodiments improve upon static manufacturing thresholds. Traditional diagnostics rely on broadly defined parameters set by manufacturers for all vehicles of a particular model. These thresholds may not account for individual driving habits, varying environmental conditions, or vehicle age. Example embodiments construct a personalized baseline from that specific vehicle's operating history. Over time, the system learns the vehicle's unique performance profile and can therefore pick up on anomalies that generic settings might never detect. By moving beyond the one-size-fits-all approach, the system ensures more accurate and timely detection of component failures, ultimately enhancing the safety, reliability, and longevity of the vehicle.

A wide range of OBD data streams and associated sensors or devices can be monitored in a cloud-based anomaly detection system, each providing insight into potential vehicle issues. Engine coolant temperature (ECT), measured by a coolant temperature sensor in the engine's cooling system, helps track operating temperature and can identify small but consistent increases that might suggest thermostat malfunctions, coolant leaks, or radiator blockages. Intake manifold absolute pressure (MAP) sensors, mounted on or near the intake manifold, reflect the engine's load and airflow characteristics, enabling the detection of potential vacuum leaks, sensor degradation, or airflow restrictions. Mass air flow (MAF) sensors, located in the intake duct, measure the volume of incoming air and can signal problems such as clogged air filters, failing sensor elements, or restricted passages when readings deviate persistently from normal values. Oxygen (O₂) and air-fuel ratio (AFR) sensors, installed in the exhaust stream before and after the catalytic converter, monitor the engine's combustion efficiency. Unusual or repeated abnormal values from these sensors may point to improper fuel injection, exhaust leaks, or a deteriorating catalytic converter.

The throttle position (TP) sensor, integrated into the throttle body, measures how far the throttle plate is open and can indicate sticking throttle plates, electronic throttle control malfunctions, or sensor faults if its data repeatedly falls outside normal bounds. Engine RPM and crankshaft position readings, sourced from a crankshaft position sensor, ensure that the engine's ignition timing is stable, flagging issues such as misfires, sensor drift, or ignition component degradation. The vehicle speed sensor (VSS), mounted on the transmission or wheel hubs, provides consistent speed data and reveals emerging transmission problems, sensor failures, or wiring issues when persistent anomalies appear.

Fuel rail pressure, captured by a fuel pressure sensor on the fuel rail, ensures stable fuel delivery, and deviations beyond normal might alert the user to failing fuel pumps, clogged filters, or leaking injectors. Short-term and long-term fuel trims (STFT/LTFT), calculated by the engine control unit from O₂ sensor data, measure how the engine management system compensates for lean or rich conditions. Sustained abnormal fuel trim values can indicate vacuum leaks, poor injector performance, or failing sensors. Engine oil pressure, measured by an oil pressure sensor within the engine's lubrication system, offers early warnings of leaks, worn pumps, or low oil levels that could lead to severe engine damage if ignored.

Evaporative emission system (EVAP) pressure or vacuum readings, supplied by EVAP pressure sensors in the fuel tank or related lines, ensure the integrity of the fuel vapor control system. Persistent deviations from normal levels might reflect leaking hoses, stuck purge valves, or other emissions-related problems. The exhaust gas recirculation (EGR) valve position sensor helps maintain proper emissions control, and steady abnormal readings can point to carbon buildup, valve sticking, or actuator issues. Transmission fluid temperature data, when available, ensures the transmission operates within safe temperature ranges, with abnormal increases suggesting fluid issues, internal slipping, or mechanical wear.

Battery voltage and charging system output, monitored via alternator feedback and voltage regulators, confirms stable electrical power supply and flags potential alternator failures, wiring faults, or battery degradation if values stray repeatedly from the norm. Knock sensor signals, originating from a knock sensor attached to the engine block, detect engine knock or ping. Repeated anomalies in this data stream may prompt investigation into ignition timing, fuel quality, or internal engine wear.

By way of particular example, a critical sensor in the engine's cooling system, such as the coolant temperature sensor, gradually starts to fail. In older diagnostic systems, it might not trigger a warning light until the reading was outright fault, such as when the engine had already started running too hot, risking damage to the head gasket or other components. In example embodiments, even subtle deviations from the established normal operating temperature range are recorded and flagged. Over time, these small but consistent temperature anomalies are recognized as an emerging issue. The driver would then receive a warning on their data device, such as via a smartphone application, prompting them to check the cooling system before the engine overheats, thereby preventing expensive repairs and potential engine damage.

In another example, a vehicle's fuel injector system starts to deliver slightly more fuel than needed. A traditional OBD system might wait until the mixture was significantly rich before signaling a problem, by which time fuel efficiency would have dropped and internal components might have begun to carbon-foul. Example embodiments pick up on the subtle drift from the average fuel injector baseline. After several minor deviations are logged, the system concludes that the injector is not performing to normal standards. The driver would be notified early, allowing them to schedule a service appointment before the issue escalates into higher emissions, poor mileage, or internal engine deposits that reduce longevity.

A final example involves an intermittently malfunctioning wheel speed sensor that feeds data to the anti-lock braking system (ABS). With traditional methods, it might fail occasionally without crossing a set error threshold. This could mean the ABS remains active in a compromised state without the driver knowing there's a developing problem. Example embodiments monitoring normal braking and wheel speed patterns, can detect these occasional misreadings. Rather than waiting for a total sensor failure, it alerts the driver early on. This allows the driver to address the issue preemptively, ensuring that the ABS remains fully functional and reduces the risk of braking performance problems that could lead to an accident.

A table listing examples of OBD live data streams and associated components that can be monitored for them is in the table below:

| | Associated Electronic | |
|---|---|---|
| OBD Live Data Stream | Component/Sensor | Description |
| Engine Coolant Temperature | Engine coolant temperature sensor | Monitor engine cooling system |
| (ECT) | | performance; deviations may |
| | | indicate overheating or cooling |
| | | system issues. |
| Mass Air Flow (MAF) | Mass air flow sensor | Measures the volume of incoming |
| | | air; abnormal readings can signal |
| | | intake obstructions, sensor drift, or |
| | | incorrect fueling. |
| Manifold Absolute Pressure | MAP sensor on intake manifold | Tracks engine load and air density; |
| (MAP) | | unusual values may indicate |
| | | vacuum leaks or sensor failure. |
| Oxygen (O2)/Air-Fuel Ratio | Pre- and post-catalyst O2 or AFR | Ensures proper combustion |
| (AFR) Sensors | sensors | mixture; persistent anomalies can |
| | | point to fuel system problems or |
| | | exhaust leaks. |
| Throttle Position (TP) | Throttle position sensor | Monitors the throttle plate angle; |
| | | unexpected fluctuations can |
| | | suggest sticking throttle or |
| | | electronic control faults. |
| Engine Speed (RPM) | Crankshaft or camshaft position | Reflects engine rotation speed; |
| | sensor | erratic data may reveal ignition |
| | | timing issues, misfires, or sensor |
| | | degradation. |
| Fuel Rail Pressure (FRP) | Fuel pressure sensor | Ensures stable fuel delivery; |
| | | abnormal pressure indicates |
| | | potential pump, injector, or filter |
| | | problems. |
| Short-Term and Long-Term | Calculated by the ECU from O₂ | Adjusts fueling to maintain ideal |
| Fuel Trims (STFT/LTFT) | sensor input | air-fuel ratio; sustained abnormal |
| | | trims suggest vacuum leaks, poor |
| | | injectors, or sensor issues. |
| Engine Oil Pressure (EOP) | Oil pressure sensor | Confirms adequate lubrication; |
| | | deviations warn of oil pump |
| | | failures, leaks, or low oil levels. |
| Vehicle Speed (VSS) | Vehicle speed sensor on transmission | Provides vehicle speed data; |
| | or wheel hubs | irregular readings may indicate |
| | | sensor faults or transmission |
| | | problems. |
| Evaporative Emission (EVAP) | EVAP pressure sensor | Checks integrity of the fuel vapor |
| System Pressure/Vacuum | | control system; anomalies suggest |
| | | leaks, stuck valves, or EVAP |
| | | malfunction. |
| Exhaust Gas Recirculation | EGR valve position sensor | Controls NOx emissions; |
| (EGR) Valve Position | | deviations from normal position |
| | | may mean carbon buildup or valve |
| | | sticking. |
| Battery Voltage and Charging | Alternator feedback, voltage regulator | Ensures stable electrical power |
| System Output | signals | supply; abnormal readings can |
| | | warn of alternator or battery |
| | | failures. |
| Knock Sensor Output | Knock sensor on engine block | Detects engine knock/ping; |
| | | repeated abnormalities may |
| | | indicate ignition timing issues or |
| | | poor fuel quality. |

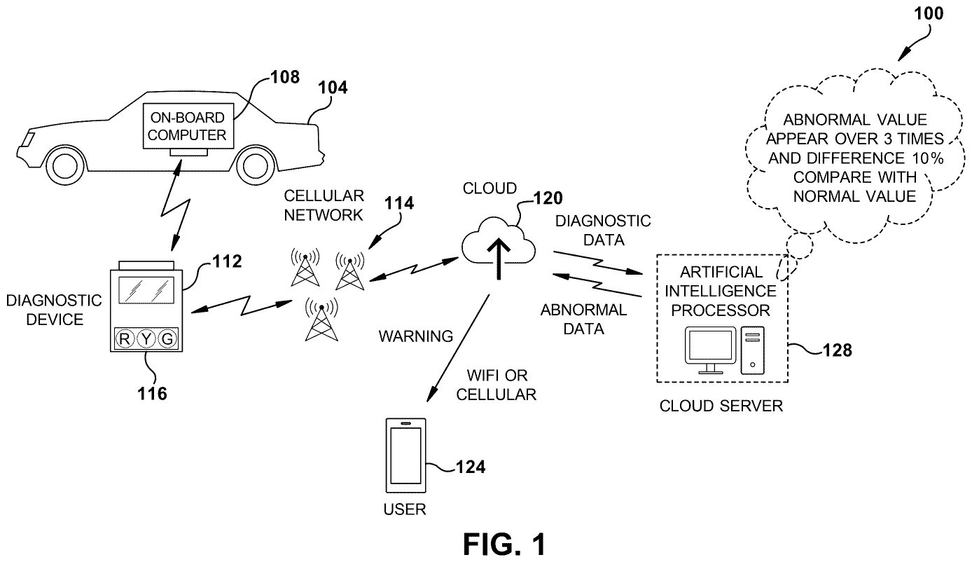

FIG. 1 illustrates an example embodiment of a system 100 for artificial intelligence based detection of automotive component failures. Vehicle 104 includes on-board diagnostic computer 108 which is placed in data communication with diagnostic device 112 by any suitable wireless or wired data connection. Diagnostic device 112 includes a user interface 116, suitably comprised of a touchscreen or other displayable indicia to indicate vehicle health. Suitable diagnostic devices can be found with Innova 5512 or 5610 OBD scanners, available from Innova Electronics Corporation, are versatile automotive diagnostic tools that can efficiently support the data collection. They connect easily to a vehicle's OBD-II port, allowing users to retrieve DTCs that pinpoint potential issues within the car's engine, transmission, or emissions systems. In addition to reading and clearing DTCs, these scanners provide live data streaming, enabling real-time monitoring of engine parameters such as RPM, coolant temperature, fuel trim, and mass air flow. By capturing both static trouble codes and continuously updated sensor data, these Innova devices offer a reliable and user-friendly solution for building a rich dataset that can be analyzed in the cloud. This capability makes them suitable for establishing normal values, detecting deviations, and integrating with advanced AI-driven maintenance tools as described herein.

In the illustrated example, indicators “R,” “Y,” and “G” on user interface 116 represent red, yellow, and green color indicators. These colors function as a quick-reference code to convey the status or health of a particular vehicle system or test result. G (Green) indicates that the system being tested is functioning properly or that a particular monitor has completed its testing cycle without detecting problems. Green generally means “go” or “all clear.” Y (Yellow) signifies a cautionary or intermediate state. A yellow indicator may mean that a monitor is not yet ready, the test is incomplete, or some values are approaching the thresholds of what is considered normal. Yellow warns that attention may soon be needed or that more driving or testing conditions must be met to complete the self-test. R (Red) represents a fail state or a detected fault. A red indicator suggests that a problem has been found, a diagnostic trouble code (DTC) may be set, or the system in question is not functioning within acceptable parameters. Red alerts the user that immediate investigation or repair is required. These color-coded status indicators provide at-a-glance information, helping technicians and drivers quickly determine whether a system is healthy, needs closer examination, or requires urgent attention.

Diagnostic device 112 is in data communication with network cloud 120, suitably via cellular network 114. Network cloud 120 is suitably comprised of any wired or wireless data carrier, alone or in combination. Network cloud 120 may be comprised of a local area network (LAN), a wide area network (WAN) which may comprise the internet, or any suitable combination thereof.

Also in data communication with network cloud 120 is user device 124, suitably a portable data device such as a smartphone or tablet. In the illustrated example, data device 124 is in wireless data communication with network cloud 120 via Wi-Fi or cellular connection. Also in data communication with network cloud 120 is cloud server 128, suitably storing DTC information, as well as previously accumulated data defining established vehicle component normal values associatively with a vehicle year, make and model. Cloud server 128 further functions to perform AI analysis to determine abnormal values, such as when a monitored value differs from an established normal value for a preset number of times, such as three times in the illustrated example. Suitable AI analysis is detailed further below.

A predetermined percentage threshold is also suitably adjusted dynamically in response to real-time environmental inputs, including ambient temperature and barometric pressure, so that the criteria for abnormal value detection remain contextually appropriate.

In the example embodiment of FIG. 1, operation includes communication of vehicle data from onboard computer 108 to diagnostic device 112, through network cloud 120 to cloud server 128. Cloud server 128 compares diagnostic data to previously determined or newly determined normal values, and generates a warning to user device 124 when a deviation is detected.

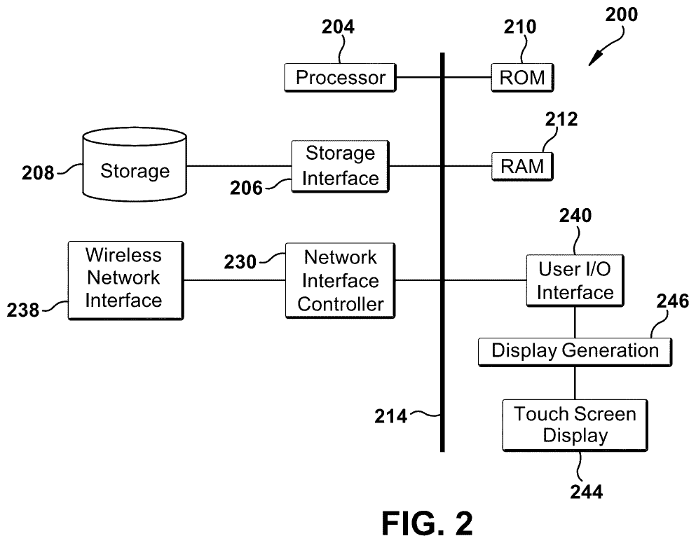

Turning now to FIG. 2, illustrated is an example embodiment of a digital data processing system 200 such as may reside in on-board computer 108, diagnostic device 112, user device 124 or cloud server 128 of FIG. 1. It is to be appreciated that some components listed may be unnecessary in certain configurations. Components of the digital data processing device 200 suitably include one or more processors, illustrated by processor 204. Storage interface 206 provides data communication with bulk data storage 208. Storage interface 206, read only memory (ROM) 210 and random access memory 212 are in mutual data communication, along with processor 204, via data bus 214. Memory is suitably non-transitory and suitable for application and data storage. Data communication among components is accomplished via data bus 214. A network interface controller 230 suitably provides a gateway for data communication with other devices, via any wireless or wired connection, such as via wireless network interface 238. A user input/output (I/O) interface 240 is suitably comprised of display generator 246 interfacing with touchscreen display 244. As noted above, any suitable user input and display can be used. I/O interface 240 is also in data communication with data bus 214.

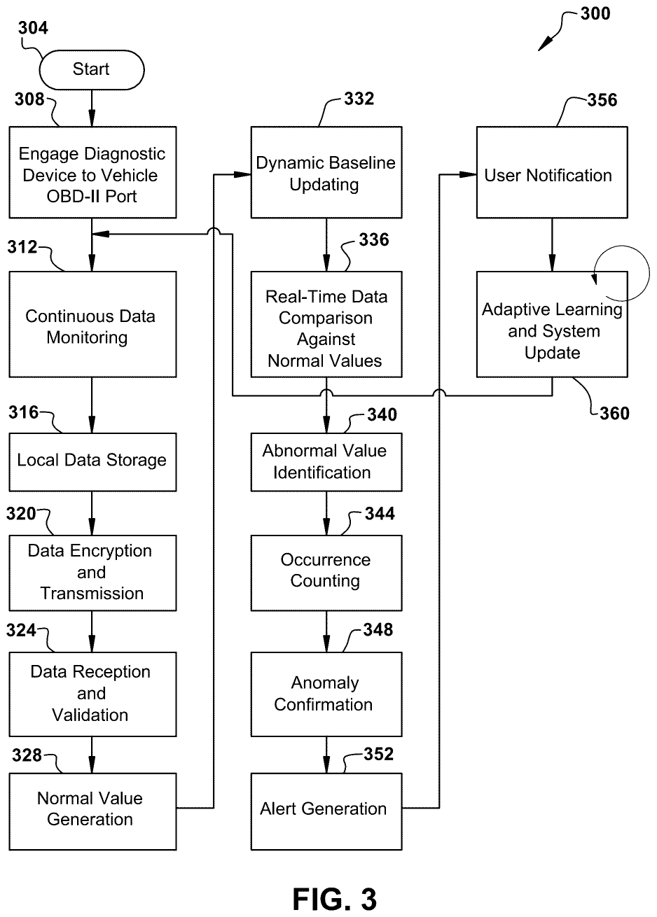

FIG. 3 illustrates a flowchart 300 of an example embodiment of an AI system for detecting automotive component failures. The system commences at block 304 and proceeds to block 308 where a vehicle diagnostic device is plugged into the vehicle's OBD-II port and activated. It establishes a connection with the vehicle's onboard computer and begins monitoring sensor data. During vehicle operation, the system collects real-time diagnostic data from multiple electronic components (e.g., engine temperature, fuel injection rates, oxygen sensor readings, etc.) at block 312. Raw data is temporarily stored in the device's memory circuit for initial processing and buffering at block 316. Collected data is encrypted and transmitted at block 320 to a cloud-based server suitably via a cellular communication module. Transmission suitably occurs either in real-time or at predefined intervals, depending on the system's configuration and network availability.

The cloud server receives encrypted diagnostic data from the vehicle at block 324. The data is decrypted, validated for integrity, and stored in a secure database. The cloud server maintains a historical database of vehicle diagnostic data. Using machine learning, the server also establishes a baseline of “normal” operating values at block 328 for each monitored component based on historical trends, environmental factors, and the vehicle's operational patterns. Dynamic baseline updating is completed at block 332. Incoming diagnostic data is compared against the baseline normal values at block 336 to detect deviations. The system evaluates a magnitude of deviation to determine abnormal readings at block 340, such as a percentage difference between the current value and the baseline (e.g., greater than 10%). Next, at block 344, when a deviation occurs a set number of times (e.g., three or more consecutive abnormal readings), an anomaly is confirmed at block 348. When an anomaly is detected, the system suitably performs additional analysis to classify the severity and urgency of the issue. This may include identifying specific components associated with the abnormal values and calculating a likelihood of impending failure based on the trend and severity of deviations.

When the system concludes that a component is at risk of failure, it generates an alert at block 352. An alert suitably includes a description of the affected component (e.g., “Oxygen Sensor”), a nature of the anomaly (e.g., “10% deviation from baseline”), and an urgency level (e.g., “Immediate attention required”). The alert is sent to the user's mobile application at block 356. The app displays the detailed warning, including actionable insights, such as recommended next steps (e.g., “Schedule maintenance for the oxygen sensor”).

After repairs or maintenance, the system updates its records with new diagnostic data. If no failure occurs, the system adapts its baseline to include the new values as part of the vehicle's normal operating range at block 360. The AI continuously refines its detection model by incorporating new data patterns from the vehicle and similar vehicles in its database, improving its accuracy and predictive capabilities over time. The process then returns to block 312 for continued monitoring.

Example embodiments provide advancements that go beyond the limitations of traditional OBD systems. Conventional systems rely on static, predefined thresholds set by manufacturers to detect faults, which apply universally across all vehicles of the same make and model. In contrast, these embodiments establish personalized baseline values for each vehicle, dynamically updated using machine learning algorithms and historical data. This approach offers a customized diagnostic experience, accounting for individual vehicle conditions and usage patterns, which conventional systems cannot achieve.

Unlike traditional OBD systems that analyze data locally and respond only after a fault has occurred, these embodiments integrate cloud storage and real-time analysis. Diagnostic data is transmitted to a cloud-based server, where it is stored and continuously compared against historical baselines. This combination of cloud computing and AI enables predictive maintenance by identifying potential faults early, before they escalate into more significant issues. Such integration of cloud and AI technologies introduces a level of functionality and scalability that is absent in conventional systems.

Example embodiments detect subtle faults through advanced anomaly detection methods. Traditional systems only trigger warnings when sensor readings exceed hard-coded thresholds, often after the component has started failing. In these embodiments, small deviations, such as a 10% variation from baseline values or recurring anomalies over three occurrences, are flagged as potential issues. By addressing these early warning signs, users can act proactively to prevent damage, which conventional systems would typically overlook.

User notification is also significantly improved in example embodiments. Traditional systems often provide only generic warnings or fault codes that require interpretation by a mechanic. In contrast, these embodiments notify users via a mobile application with detailed, actionable insights about specific components and the urgency of the issue. This feature transforms diagnostic data into meaningful information, empowering users to address problems directly and promptly.

Real-time, AI-driven analysis is also used advantageously. Instead of relying on static, rules-based fault detection, the AI processes streaming diagnostic data and compares it against adaptive baselines stored in the cloud. This capability allows for continuous monitoring and predictive fault detection, a significant departure from older, reactive systems. Additionally, multi-factor anomaly detection is used, combining criteria such as the frequency of abnormal values, percentage deviations, and historical data trends. This comprehensive analysis ensures a higher level of accuracy and reliability in detecting faults.

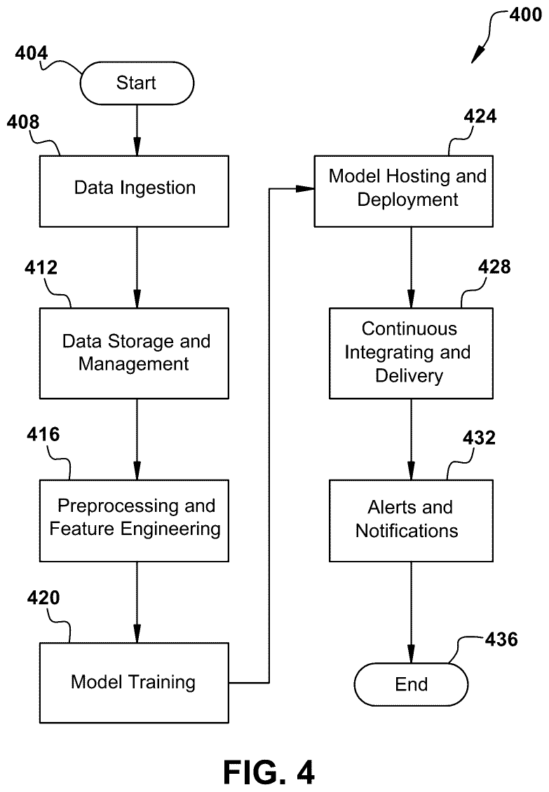

An example embodiment of an AI/ML platform that is suitably integrated into this automotive diagnostic solution is a cloud-based machine learning pipeline built on services such as Amazon Web Services (AWS) SageMaker combined with secure data ingestion and storage solutions like AWS IoT Core and Amazon S3. Referring to FIG. 4, AI operation 400 commences at block 404. Data ingestion occurs at block 408 wherein a vehicle's diagnostic device sends encrypted sensor data to the cloud through a secure endpoint. AWS IoT Core suitably serves as the ingestion point, subscribing to topics for each vehicle or component type. Incoming data is queued, validated, and prepared for analysis.

Once ingested, raw diagnostic data is stored at block 412 in Amazon S3. S3 acts as a scalable data lake, holding both current streaming data and historical archives. Historical datasets are essential for defining and periodically refining normal baseline values.

Preprocessing and feature engineering is then performed at block 416. Prior to feeding data into the ML models, AWS Glue or AWS Lambda functions suitably cleans and preprocess the data. This suitably includes:
Normalizing sensor readings to a common scale.
Aggregating data over time windows (e.g., hourly averages).
Filtering out obviously corrupted or incomplete readings.
Feature engineering routines identify the critical attributes needed for anomaly detection models, such as average component values over different operational conditions or specific statistical measures (mean, median, variance) that indicate the normal operating range.

Next, model training is completed at block 420. Amazon SageMaker is suitably used to develop, train, and tune the ML models. The initial model is suitably an unsupervised anomaly detection algorithm, such as Isolation Forest or an autoencoder neural network, trained on historical “healthy” data. These baseline models learn the normal pattern of sensor readings. As the system accumulates more data, SageMaker can retrain or fine-tune the models to adapt to changes in vehicle performance over time at block 428. Trained models are suitably deployed as endpoints on SageMaker. These endpoints run continuously, ready to evaluate incoming data streams in near real-time. The model's inference API can be accessed from the data pipeline so that every new batch of sensor data is analyzed against the learned baseline. Services like AWS CodePipeline and CodeBuild, the platform support continuous improvement. Whenever new training data is available or model performance metrics suggest a need for refinement, a retraining job can be triggered automatically. This ensures that models remain current and effective as the vehicle's operational profile evolves. Model hosting and deployment is then accomplished at block 424.

Next results of the anomaly detection are fed into AWS Lambda or Amazon SNS (Simple Notification Service) to generate user alerts at block 432. If the model's inference indicates that a reading deviates more than 10% from the baseline and this has happened at least three times, a message is sent to the user's mobile application. The user alert logic can also leverage Amazon DynamoDB to track recent anomaly counts and timestamps for each component. Over time, as repairs are made or as the vehicle's normal behavior shifts, the model is retrained with updated data. This allows the baseline to adapt, ensuring that what was once considered abnormal may become normal for the vehicle as it ages, or vice versa. The process then ends at block 436.

This example embodiment provides an integrated AI/ML platform that leverages scalable, cloud-based data ingestion, secure storage, flexible preprocessing, automated model training, and continuous model deployment. Its design ensures that the system can evolve as more data is gathered, refining the detection of abnormal conditions and improving predictive maintenance capabilities over the life of the vehicle.

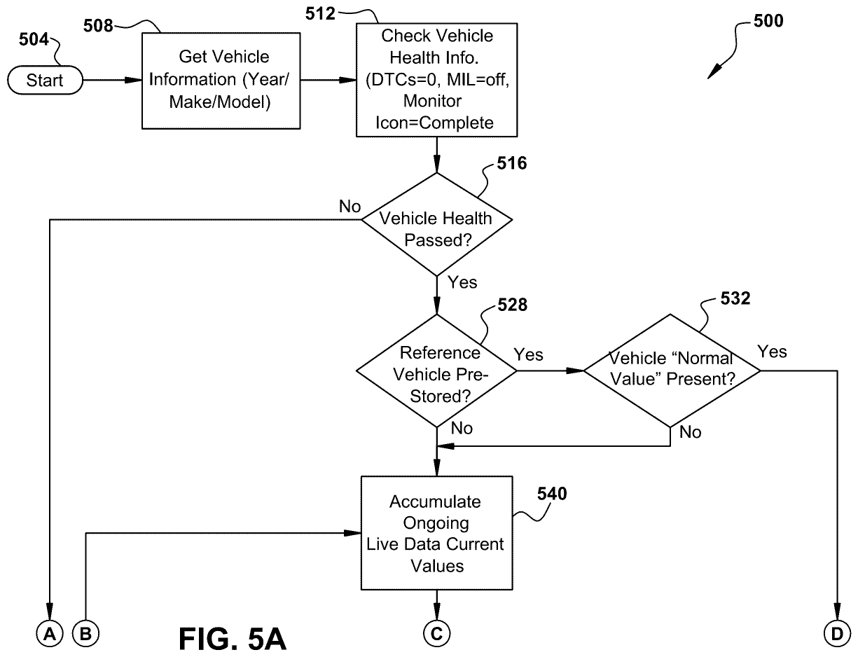

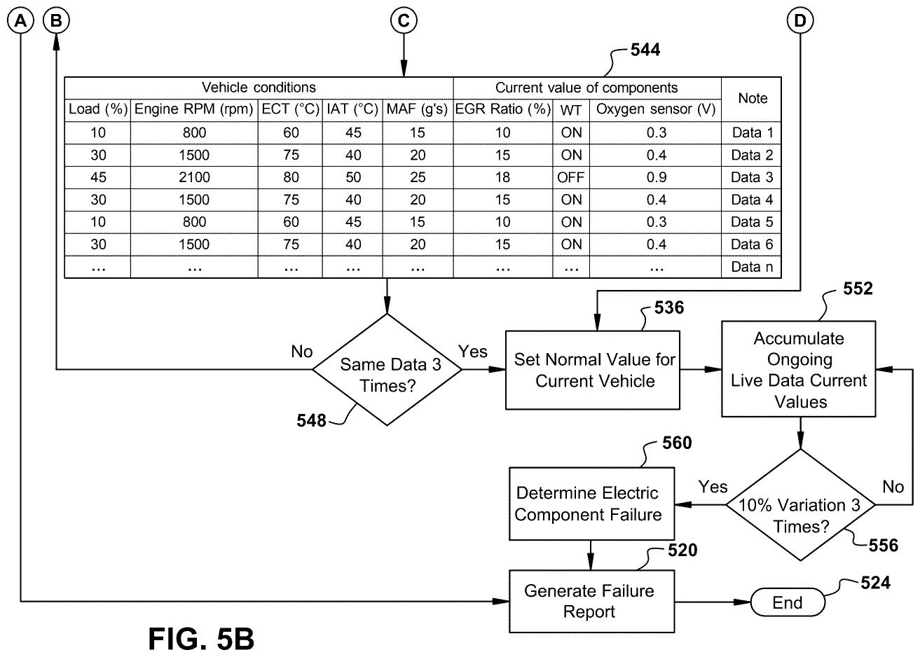

FIGS. 5A and 5B illustrate a flowchart 500 of an example embodiment of a use case for an AI system for detecting automotive component failures. The system commences at block 504 and proceeds to block 508 where vehicle information, such as year, make and model, is determined. This information is suitably obtained from OBD information which may include a Vehicle Identification Number (VIN). A VIN is a unique 17-character code assigned to every vehicle at the time of manufacturing. This alphanumeric sequence ensures that no two vehicles have the same number. The VIN reveals details such as the manufacturer's name, the country of production, the year of manufacture, the brand, the engine type, and the body style. It also encodes a vehicle's safety features, model, and serial number.

Once the vehicle has been identified, a vehicle health check is made for OBD information at block 512. When a vehicle's onboard diagnostics system reports zero DTCs, the Malfunction Indicator Lamp (MIL) is off, and the monitor icons are marked as “complete,” it generally indicates that the vehicle is operating as intended and is in good overall health. No DTCs means the car's computer has not detected any faults or irregularities in the sensors, systems, or components in monitors. The MIL, often called the “check engine light,” turns on when there's a problem that needs attention; since it's off, it suggests there are no pressing issues at the moment. Additionally, when monitor icons are “complete,” it means that the various self-tests the vehicle runs on its emissions-related components have successfully finished and found no problems. Taken together, these conditions imply that the vehicle's engine, emissions systems, and critical components are functioning properly. Next, a determination is made at block 516 as to whether the vehicle health check passed. If not, a failure report is generated at block 520 and the process ends at block 528.

If the vehicle health test is passed at block 516, the system proceeds to block 528 where a check is made as to whether information for the vehicle is already stored. If it is, a check is made at block 532 to determine if a Normal Value has been established. If so, the Normal Value for the vehicle is set at block 536. If no pre-stored reference vehicle information is present, or if it is present without an established Normal Value, the system proceeds to block 540 where ongoing OBD live data is obtained from the vehicle OBD port. OBD live data is real-time information provided by a vehicle OBD system as the engine is running. This data includes sensor readings, component statuses, and system parameters, such as engine speed, coolant temperature, oxygen sensor values, vehicle speed, and fuel trim levels, continuously generated by the car's ECU. Live data shows how the vehicle's systems behave under actual operating conditions.

Table 544 details an example procedure for determining a Normal Value for each automotive component under specific, repeatable vehicle operating conditions. The system continuously monitors the vehicle's sensors and, when certain conditions are met, it records the component values. If the same component value is observed three times under the same conditions, that value is set as the “Normal value” for that component at those conditions. The table includes representative vehicle operation parameters comprising:
EGR (Exhaust Gas Recirculation): A system that redirects a portion of the exhaust gases back into the engine cylinders to reduce nitrogen oxide (NOx) emissions.
VVT (Variable Valve Timing): A technology that adjusts the timing of the engine's intake or exhaust valves to improve performance, fuel economy, and emissions control.
ECT (Engine Coolant Temperature): A measurement of the temperature of the engine's coolant fluid, indicating how warm or cool the engine is running.
IAT (Intake Air Temperature): A measurement of the temperature of the air entering the engine's intake manifold. This helps the engine control unit (ECU) adjust the air-fuel mixture.
MAF (Mass Air Flow): A sensor that measures the mass of air flowing into the engine. The ECU uses this data to calculate the correct amount of fuel to deliver.
RPM (Revolutions Per Minute): A measure of how many times the engine's crankshaft rotates in one minute, indicating the engine's speed.

Table 544 illustrates conditions, Data 2, Data 4 and Data 6, where the vehicle load is 30%, the engine speed (RPM) is 1500, the engine coolant temperature (ECT) is 75° C., the intake air temperature (IAT) is 40° C., and the mass air flow (MAF) is 20 g/s. Under these conditions, the system has noted three separate times that the exhaust gas recirculation (EGR) ratio is 15%, the variable valve timing (VVT) is ON, and the oxygen sensor reading is 0.4%. Because the same values appeared three times under identical conditions, the system establishes these values as the Normal Values for EGR, VVT, and the oxygen sensor at that particular operating state.

This process is repeated for other sets of conditions. Over time, the system builds a comprehensive baseline of what Normal values look like for each component under a range of operating scenarios. This baseline can then be used to detect when a component's value deviates from normal, potentially signaling an abnormal condition or impending failure. Established values are checked at block 548 to determine if they occur a set number of times, such as three times in the illustrated example. If not, the process returns to block 540. If so, the Normal Value is established at block 536.

When a Normal Value is established at block 536, the system continues to accumulate live data at block 552. Live data is checked until an established variation from the Normal Value occurs a set number of times as determined by block 556, with three times being that value in the illustrated example. When this threshold is achieved, the process proceeds to block 560 where a component failure is determined. The process then proceeds to block 520 for generation of a failure report before ending at block 524.

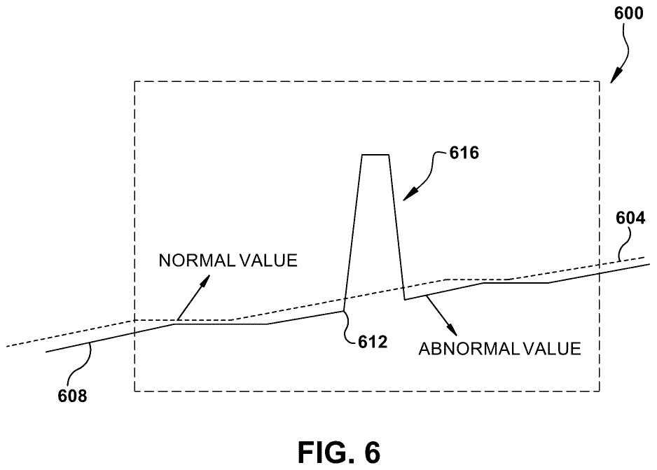

FIG. 6 illustrates line graph 600. The graph displays two overlapping curves to compare what is considered normal operating behavior against a scenario containing an abnormal event. Curve 604, represented by a dotted line, traces a gradually rising slope over time. This dotted line is labeled Normal Value,” signifying the expected range and trend of the measured parameter, such as a sensor reading or system output, under ordinary, healthy conditions. It rises slowly, reflecting minor, acceptable changes due to normal wear, warm-up cycles, or environmental factors. However, it never strays far from the baseline considered typical.

Superimposed on dotted line 604 is solid line 608, also showing a similar gradual upward slope, but with a critical difference: at point 612 along its progression, the line exhibits a sudden, sharp spike 616 that significantly exceeds the dotted normal value line 604 gentle incline. This spike stands out as an abrupt deviation from the slow, steady trend. Because of this irregularity, the entire solid line is labeled “abnormal value.” This illustrates that, while both lines show a general upward drift, dotted line 604 illustrates what would be considered an acceptable or “normal” increase, whereas the solid line's abrupt jump indicates a clear anomaly. This anomaly might be caused by a temporary sensor fault, a sudden mechanical issue, or a short-lived condition that pushes the reading well outside the normal operating envelope defined by the dotted line.

In essence, the graph provides a visual comparison between a hypothetical ideal or normal performance trajectory (dotted line 604) and a real or abnormal performance trajectory (solid line 608) that includes a notable, abnormal spike. Viewing both lines together demonstrates how observed data diverges from the expected standard at a critical point, highlighting the presence of a fault or unusual event that needs attention.

In a further example embodiment, a severity rating is suitably applied to each identified abnormal value based on the magnitude of its deviation from the normal value and the frequency of its occurrence, wherein higher severity ratings prompt more urgent user alerts.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of detecting abnormal conditions in automotive components on a vehicle equipped with an onboard diagnostic device in data communication with a cloud-based server and at least one user device, the method comprising:
receiving streaming diagnostic data corresponding to at least one component of the vehicle during operation;
transmitting the streaming diagnostic data to the cloud-based server for processing;
at the cloud-based server, generating a normal value based on historical diagnostic data of the component;
comparing newly received streaming diagnostic data to the normal value;
identifying an abnormal value if the streaming diagnostic data deviates from the normal value by more than a predetermined threshold;
determining whether such abnormal values occur at least a predetermined number of times; and
upon reaching said predetermined occurrence count, transmitting a user notification via an application indicating the presence of an abnormal condition.

2. The method of claim 1, wherein the predetermined threshold at which a value is deemed abnormal is in the range of 5% to 15% above or below the normal value, thereby capturing deviations that are likely to indicate component degradation or malfunction.

3. The method of claim 1, wherein the predetermined number of times that the abnormal values must appear before notifying the user is at least three (3), such that persistent or recurring anomalies trigger a user alert.

4. The method of claim 1, further comprising continuously refining the normal value over time by incorporating newly acquired historical data to modify the normal value in accordance with changes in the vehicle's operating conditions, component wear, or environmental factors.

5. The method of claim 1, further comprising assigning a severity rating to each identified abnormal value based on the magnitude of its deviation from the normal value and the frequency of its occurrence, wherein higher severity ratings prompt more urgent user alerts.

6. The method of claim 1, wherein the user notification includes one or both of an identification of the component exhibiting the abnormal values and recommended maintenance actions.

7. The method of claim 1, further comprising integrating machine learning algorithms within the cloud-based server to continuously improve the accuracy of normal value determination and anomaly detection.

8. An apparatus for detecting abnormal conditions in automotive components on a vehicle equipped with an onboard diagnostic device in data communication with a cloud-based server and at least one user device, the apparatus comprising:
a diagnostic interface configured to receive streaming diagnostic data corresponding to at least one component of a vehicle;
a communication module configured to securely transmit said streaming diagnostic data to a cloud-based server; and
a processor configured to
establish a historical dataset from which a normal value is generated,
compare incoming streaming diagnostic data to said normal value to detect deviations exceeding a predetermined threshold value,
determine if such deviations occur a predetermined number of times, and
initiate a user notification upon detection of deviations exceeding the predetermined threshold value and predetermined number of times.

9. The apparatus of claim 8, wherein the communication module is configured to encrypt diagnostic data using a secure encryption protocol, thereby preserving data privacy and preventing unauthorized access during transmission to the cloud-based server.

10. The apparatus of claim 8 further comprising a user alert subsystem that, upon instructions from the cloud-based server, interfaces with a user's mobile application to present information about the abnormal condition, including one or both of an identity of the component and suggested maintenance actions.

11. The apparatus of claim 8, wherein the processor is configured to dynamically update the normal value as additional historical diagnostic data accumulates, thus ensuring that the baseline reflects current and evolving vehicle performance parameters.

12. The apparatus of claim 8, wherein the processor and cloud-based server employ one or more machine learning models to enhance the detection of abnormal values over time, refining both the threshold value and normal value determination as the vehicle continues to operate and generate new data.

13. The apparatus of claim 8, further comprising data storage modules configured to locally buffer diagnostic data prior to transmission, allowing for seamless data integrity checks and retransmission in case of network interruptions or packet loss.

14. The apparatus of claim 8, wherein the diagnostic interface conforms to an OBD-II standard, enabling broad compatibility across a range of vehicle makes and models, and facilitating simple installation and operation.

15. A computer program product comprising one or more non-transitory computer-readable media storing instructions executable by one or more processors to perform operations for detecting abnormal conditions in automotive components on a vehicle equipped with an onboard diagnostic device in data communication with a cloud-based server and at least one user device, the operations comprising:
receiving streaming diagnostic data from a component of a vehicle,
transmitting said data to a cloud-based server;
retrieving from the server a normal value generated based on historical data;
comparing current streaming data against this normal value to determine a percentage difference; and
classifying the current data as abnormal when it exceeds a predetermined threshold for a predetermined number of times.

16. The computer program product of claim 15, wherein the operations further comprise adapting and refining the normal value over time, incorporating newly acquired historical data to maintain an accurate and current baseline representative of the vehicle's operational profile.

17. The computer program product of claim 15, wherein the operations further comprise triggering a user notification through a designated mobile application upon confirming multiple occurrences of abnormal values, thereby proactively informing the user of potential component issues.

18. The computer program product of claim 15, wherein the operations further comprise encrypting diagnostic data before and during transmission to the cloud-based server, ensuring that sensitive vehicle information remains protected against unauthorized access.

19. The computer program product of claim 15, wherein the operations further comprise employing a machine learning model trained on historical diagnostic data to enhance anomaly detection accuracy, enabling more reliable identification of early-stage component failures and reducing false alarms.

20. The computer program product of claim 15, wherein the operations further comprise storing anomaly events, frequency counts, and related metadata, enabling retrospective analysis and assisting maintenance technicians or fleet operators in identifying chronic issues, confirming repairs, and improving overall vehicle reliability.

21. The computer program product of claim 15, wherein the operations further comprise integrating a machine learning model that refines normal values and improves anomaly detection accuracy as more data is gathered, thereby adapting to the vehicle's evolving operating conditions.

22. A method of detecting abnormal conditions in automotive components on a vehicle equipped with an onboard diagnostic device in data communication with a cloud-based server and at least one user device, the method comprising:
receiving streaming diagnostic data corresponding to at least one component of the vehicle during operation;
generating a normal value based on historical diagnostic data of the component;
comparing newly received streaming diagnostic data to the normal value;
identifying an abnormal value if the streaming diagnostic data deviates from the normal value by more than a predetermined threshold;
determining whether such abnormal values occur at least a predetermined number of times; and
upon reaching said predetermined occurrence count, transmitting a user notification via an application indicating the presence of an abnormal condition.

23. A computer program product comprising one or more non-transitory computer-readable media storing instructions executable by one or more processors to perform operations for detecting abnormal conditions in automotive components on a vehicle equipped with an onboard diagnostic device in data communication with a cloud-based server and at least one user device, the operations comprising:
receiving, at the cloud-based server, streaming diagnostic data from the onboard diagnostic device corresponding to at least one automotive component of the vehicle;
generating a normal value by aggregating and averaging historical diagnostic data of the at least one automotive component;
comparing newly received streaming diagnostic data to the normal value to determine whether a difference exceeds a predetermined threshold;
identifying an abnormal value when the difference exceeds the predetermined threshold;
determining whether the abnormal value occurs at least a predetermined number of times; and
transmitting, upon detecting that the abnormal value occurs at least the predetermined number of times, a user notification indicating the presence of the abnormal condition.
